(19) United States
(12) Patent Application Publication
(10) Pub. No.: US 2014/0149445 A1
(43) Pub. Date: May 29, 2014

(54) WEBPAGE QUERYING SYSTEM AND QUERYING METHOD THEREOF

(71) Applicants: INVENTEC (PUDONG) TECHNOLOGY CORPORATION, Shanghai (CN); INVENTEC CORPORATION, Taipei (TW)

(72) Inventor: Tao ZHOU, Shanghai (CN)

(73) Assignees: INVENTEC CORPORATION, Taipei (TW); INVENTEC (PUDONG) TECHNOLOGY CORPORATION, Shanghai (CN)

(21) Appl. No.: 13/832,078

(22) Filed: Mar. 15, 2013

(30) Foreign Application Priority Data
Nov. 26, 2012 (CN) 201210488373.9

(51) Int. Cl. G06F 17/30

(52) U.S. Cl. CPC G06F 17/30427
USPC 707/760

(57) ABSTRACT

A webpage querying system and a querying method thereof are provided. By translating a first language word into a second language word, querying websites according to the second language word and the first language word separately to obtain query results, and translating the query result of the second language word into a first language for displaying together with the query result of the first language word, the technical efficacy of improving the richness of word explanation is achieved.

### BACKGROUND OF THE INVENTION

1. Field of the Invention

The present invention relates to a querying system and a querying method thereof, and more particularly to a webpage querying system and a querying method thereof, which apply specialized words of different languages with the same meaning to query for word explanation and translate the word explanation.

2. Description of Related Art

In recent years, with the popularity of computers and vigorous development of networks, a word query program is also gradually combined with the network to provide a user with more diversified applications.

Generally, a conventional word query program is to receive a first language word input by the user, for example, “apple”, and then query a database thereof for first language explanation, a second language and second language explanation of the word. However, the content of the database is preset and cannot be changed or added in real time, which causes the problem of inadequacy of the word explanation.

In view of this, some manufacturers propose to download a dictionary file through the network, to update the database of the word query program. Thereby, the content of the database is added by updating the database. However, the content of the database added in this manner is still limited, because in consideration of the file size and network transmission rate, it is difficult to add detailed explanation content to each word in the database. Especially the explanation content of specialized words generally only has comparisons and brief descriptions of different languages, and lacks related technical details, so limited help is provided for the user. Therefore, the foregoing manner still cannot effectively solve the problem of inadequacy of the word explanation.

To sum up, it can be known that in the prior art, the problem of inadequacy of the word explanation exists for a long time, so it is actually necessary to propose improved technical means to solve this problem.

### SUMMARY OF THE INVENTION

In view of the problem existing in the prior art, the present invention discloses a webpage querying system and a querying method thereof.

The webpage querying system disclosed in the present invention includes: a receiving module, an association module, a querying module, a translating module and displaying module. The receiving module is used for receiving a first language word. The association module is used for translating the first language word into a second language word with the same meaning. The querying module is used for transmitting the first language word to a plurality of websites comprising the first language word for query, and receiving a plurality of query results fed back by the websites, the querying module also used for transmitting the second language word to a plurality of websites comprising the second language word for query, and receiving a plurality of query results fed back by the websites. The translating module is used for translating the query result including the second language word into the first language. The displaying module is used for displaying the first language query result which includes word originally in the first language word and word translated from the second language word.

The webpage querying method of the present invention includes: receiving a first language word; translating the first language word into a second language word with the same meaning; transmitting the first language word to a plurality of websites comprising the first language word for query, and receiving a plurality of query results which comprising the first language word fed back by the websites; transmitting the second language word to a plurality of websites comprising the second language word for query, and receiving a plurality of query results which comprising the second language word fed back by the websites; translating the query result including the second language word into the first language; and displaying the first language query result which includes word originally in the first language word translated from the second language word.

The system and the method disclosed by the present invention are described above, and the difference between the present invention and the prior art lies in that in the present invention, a first language word is translated into a second language word, websites are queried according to the second language word and the first language word separately to obtain query results, and the query result of the second language word is translated into a first language for displaying together with the query result of the first language word.

Through the foregoing technical means, the present invention may achieve the technical efficacy of improving the richness of word explanation.

### BRIEF DESCRIPTION OF THE DRAWINGS

The invention will become more fully understood from the detailed description given herein below illustration only, and thus is not limitative of the present invention, and wherein:

FIG. 1 is a system block diagram of a webpage querying system of the present invention.

FIG. 2 is a flow chart of a webpage querying method of the present invention.

FIG. 3 is a schematic diagram of a query window applying the present invention.

FIG. 4 is a schematic diagram of an address of a website edited by applying the present invention.

### DESCRIPTION OF THE EMBODIMENTS

The present invention will be apparent from the following detailed description, which proceeds with reference to the accompanying drawings, wherein the same references relate to the same elements.

Before the webpage querying system and the querying method thereof disclosed in the present invention are illustrated, terms defined in the present invention are explained first. In the present invention, a word field refers to the technical field where the word is used, such as: an electronic field and a financial field. For example, the word field of the word “relay” is the “electronic field”, and the word field of the word “convertible company bond” is the “financial field”.

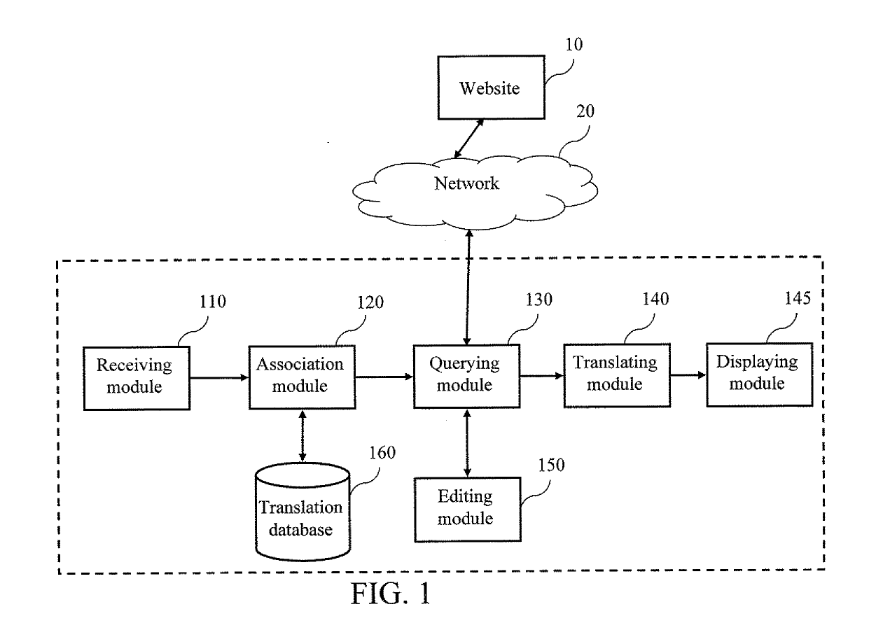

The webpage querying system and the querying method thereof of the present invention are further illustrated below with reference to the accompanying drawings. Referring to FIG. 1, FIG. 1 is a system block diagram of a webpage querying system of the present invention. The system includes: a receiving module 110, an association module 120, a querying module 130, a translating module 140 and a displaying module 145. The receiving module 110 is used for receiving a first language word, and the first language word may be a mother language word or other language words. In practical implementation, the receiving manner may be implemented through user typing or cursor capturing. The receiving manner is a conventional technology, and therefore is not illustrated anymore herein.

The association module 120 is used for translating the first language word into a second language word with the same meaning, for example, translating a first language word “relay (in Chinese)” into a second language word “relay” or translating a first language word “battery (in Japanese)” into a second language word “battery (in Chinese)”. In other words, the first language word and the second language word refer to words of different languages with the same meaning. It should be particularly noted that, in practical implementation, the translated second language word may also include languages of multiple nations, for example, the first language word “battery (in Japanese)” is translated into the second language words “battery (in Chinese)” and “battery”, and so on.

Additionally, in a translation process, the association module 120 may also receive the word field set by the user to filter the translated second language word. For example, assuming that the first language word is “relay” and the word field is “electronic field”, when translating the first language word “relay”, the association module 120 may obtain a plurality of second language words, such as Chinese words. The association module 120 then filters the “relay (in Chinese)” as the second language word according to the word field “electronic field”. The filtering manner may include: judging the word field according to explanation content of the second language word, and selecting the second language word conforming to the word field. For example, the explanation content of the second language word is “[Verb] . . . ” and the explanation content of the second language word is “[Electronics] . . . ”. At this time, the word field of the second language word “[Verb] . . . ” may be regarded as a “common field”, and the word field of the second language word “[Electronics] . . . ” may be regarded as an “electronic field”. When the word field is the “electronic field”, the association module 120 judges that the word field of the second language word conforms to the received word field. Additionally, the association module 120 may also receive a selection language family set by the user to filter the second language word. For example, when the user sets Chinese, the association module 120 uses Chinese as the selection language family, and filters the second language word which is also Chinese from the second language words of different languages.

The querying module 130 is used for transmitting the first language word and the second language word separately to a plurality of websites 10 including the first language word and the second language word for query, and receiving a plurality of query results fed back by the websites 10. For example, assuming that the first language word is “relay (in Chinese)” and the second language word is “relay”, the querying module 130 first loads an address of the website 10 including the first language word, such as: “http://zh-tw.wikipedia.org/wiki/” and an address of the website 10 including the second language word, such as: “http://en.wikipedia.org/wiki/”, then queries the first language word “relay (in Chinese)” and the second language word “relay” separately through a network 20 by combining the foregoing loaded two addresses in a parameter transmission manner (namely, querying separately through the combined addresses “http://zh-tw.wikipedia.org/wiki/relay” and “http://en.wikipedia.org/wi-ki/relay”), and receives the query results fed back by the two websites 10 respectively. The query results may be webpage files and include a HyperText Markup Language (HTML) and a script language such as: “Java Script”. It should be particularly noted that, in practical implementation, the user may set a plurality of addresses of the websites, and therefore, the language used by each website 10 may be different, which causes that the language used in the query result fed back by each website 10 may be different. Additionally, when transmitting the second language word to the preset website 10 using the same language, the querying module 130 may also transmit a limiting condition to adjust the query result. The limiting condition at least includes nation, file type or time range. The usage of the limiting condition is illustrated in detail with reference to the accompanying drawings later.

The translating module 140 is used for translating the query result including the second language word into the first language. As mentioned above, the languages used by the websites 10 may be languages of different regions or nations, such as: “Cantonese”, “English” or “French”. Therefore, the translating module 140 translates the query result including the second language word that is received by the querying module 130 into the first language, such as: “Chinese”. The technology for translating the query result is a conventional technology, and therefore is not illustrated anymore herein.

The displaying module 145 is used for displaying the first language query result which includes word originally in the first language word and word translated from the second language word, for the user to browse conveniently.

Additionally, the webpage querying system may further include an editing module 150 and a translation database 160. The editing module 150 is used for pre-storing addresses of the websites 10, and permitting the user to edit the addresses, for example, modifying “http://www.it.com” into “http://www.business.com”. The translation database 160 is used for pre-storing the first language word and the corresponding second language word for the association module 120 to translate. The first language word may be a mother language word, and the second language word includes regional and national language family word. For example, the regional language family word may be a word of Taiwanese or Cantonese, and so on, and the national language family word may be a word of Chinese, English or France, and so on. In practical implementation, the translation database 160 may be a relational database for improving query efficiency and operation convenience.

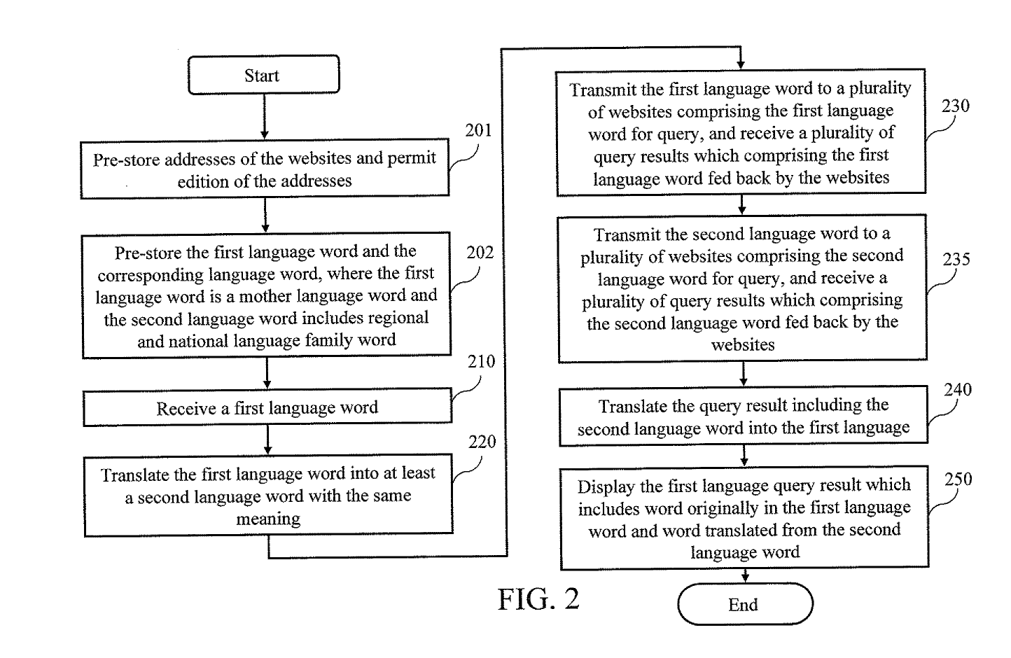

Next, referring to FIG. 2, FIG. 2 is a flow chart of a webpage querying method of the present invention, which includes: receiving a first language word (step 210); translating the first language word into a second language word with the same meaning (step 220); transmitting the first language word to a plurality of websites 10 comprising the first language word for query, and receiving a plurality of query results which comprising the first language word fed back by the websites 10 (step 230); transmitting the second language word to a plurality of websites 10 comprising the second language word for query, and receiving a plurality of query results which comprising the second language word fed back by the websites 10 (step 235); translating the query result including the second language word into the first language (step 240); and displaying the first language query result which includes word originally in the first language word and word translated from the second language word (step 250). Through the foregoing steps, the first language word is translated into the second language word, the websites 10 are queried according to the second language word and the first language word separately to obtain the query results, and the query result of the second language word is translated into the first language for displaying together with the query result of the first language word.

It should be particularly noted that, before step 210, addresses of the websites 10 may be pre-stored and a user is permitted to edit the addresses (step 201); or the first language word and the corresponding second language word are pre-stored, where the first language word may be a mother language word, and the second language word may include regional and national language family word (step 202). In practical implementation, the addresses of the websites 10 may also be stored in a relational database. Storing and edition of the relational database are conventional technologies, and therefore are not illustrated anymore herein.

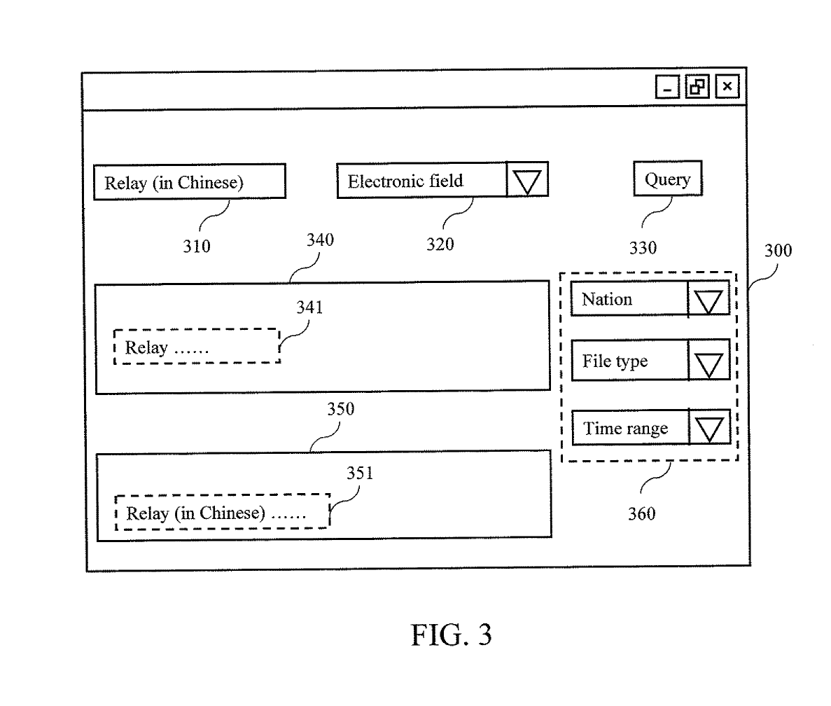

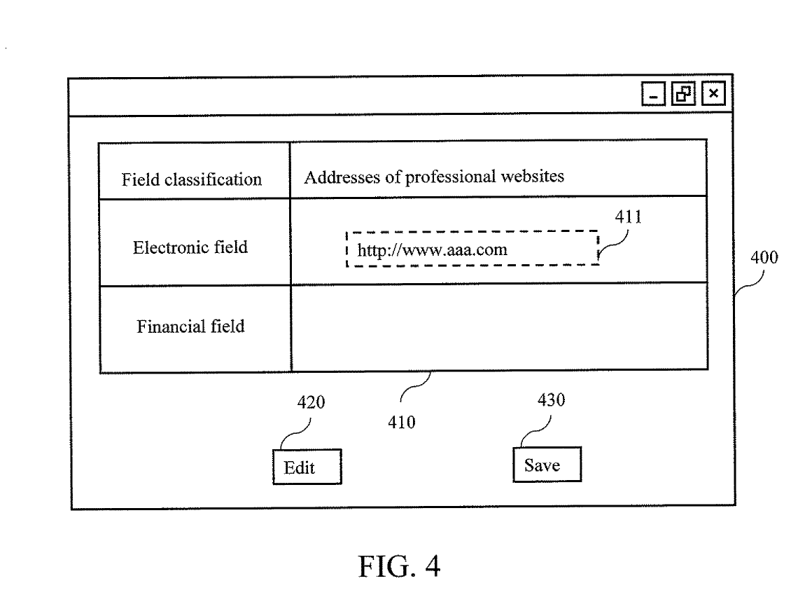

Embodiments are illustrated below with reference to FIG. 3 and FIG. 4. Referring to FIG. 3, FIG. 3 is a schematic diagram of a query window applying the present invention. When a user intends to query for “relay (in Chinese)”, the user may type “relay (in Chinese)” in an input block 310 of a query window 300, select “electronic field” through a field selection component 320, and then click a querying component 330. At this time, the receiving module 110 receives setting of the input block 310 and uses “relay (in Chinese)” as a first language word. The association module 120 translates the first language word “relay (in Chinese)” into a second language word, and the translation process may include: filtering the second language word conforming to the “electronic field”, such as: “relay”, according to setting of the field selection component 320. The querying module 130 transmits the first language word “relay (in Chinese)” and the second language word “relay” separately to the websites 10 including the first language word and the second language word for query, and obtains query results (341, 351) fed back by the websites 10 respectively. In the electronic field, the website 10 may be an electronic journal website of Institute of Electrical and Electronics Engineers (IEEE). After the query results (341, 351) are obtained, the translating module 140 translates the query result 341 including the second language word into a first language for displaying in a display block 340, and displays the query result 351 including the first language word in a display block 350. So far, the entire query process is completed.

It should be particularly noted that, before clicking the querying component 330, the user may further set conditions such as nation, file type or time range through a condition block 360 to narrow down the query range. The querying module 130 uses the nation, file type or time range set by the user as a limiting condition and transmits the limiting condition to the websites 10. In this way, a more precise query result is obtained.

Referring to FIG. 4, FIG. 4 is a schematic diagram of an address of a website edited by applying the present invention. As mentioned above, the editing module 150 pre-stores the addresses of the websites 10, and permits the user to edit the addresses. In practical implementation, an editing window 400 may be opened by pressing a function key, and an editing block 410 lists addresses of websites in different fields, such as: an address 411 of the electronic field “http://www.aaa.com”. The user may enable the editing block 410 to be editable by clicking an editing component 420, and after the edition is completed, save by clicking a storage component 430. It should be particularly noted that, the same field classification may store a plurality of addresses of the website 10 at the same time, for example, the address of the website 10 corresponding to the electronic field may be “http://www.aaa.com” and “http://www.bbb.com” at the same time. Although the present invention uses the foregoing examples to illustrate the editing manner of the address, the present invention is not limited thereto, and any manner through which the user can set the addresses of the websites 10 in different fields falls within the application scope of the present invention.

To sum up, it can be known that the difference between the present invention and the prior art lies in that, a first language word is translated into a second language word, websites are queried according to the second language word and the first language word separately to obtain query results, and the query result of the second language word is translated into a first language for displaying together with the query result of the first language word. Therefore, this technical means may solve the problem existing in the prior art, so as to achieve the technical efficacy of improving the richness of word explanation.

What is claimed is:

1. A webpage querying system, comprising:
a receiving module, uses for receiving a first language word;
an association module, used for translating the first language word into at least a second language word with the same meaning;
a querying module, used for transmitting the first language word to a plurality of websites comprising the first language word for query, and receiving a plurality of query results fed back by the websites, the querying module also used for transmitting the second language word to a plurality of websites comprising the second language word for query, and receiving a plurality of query results fed back by the websites;
a translating module, used for translating the query result comprising the second language word into the first language; and
a displaying module, used for displaying the first language query result which includes word originally in the first language word and word translated from the second language word.

2. The webpage querying system according to claim 1, further comprising: an editing module, used for pre-storing addresses of the websites and permitting edition of the addresses.

3. The webpage querying system according to claim 1, further comprising: a translation database, used for pre-storing the first language word and the corresponding second language word for the association module to translate, wherein the first language word is a mother language word, and the second language word comprises regional and national language family word.

4. The webpage querying system according to claim 1, wherein when transmitting the second language word to a preset website using the same language, the querying module further transmits at least a limiting condition to adjust the query result, the limiting condition at least comprising nation, file type or time range.

5. The webpage querying system according to claim 1, wherein the association module is further used for filtering the second language word according to a word field, and receiving a selection language family to filter the second language word.

6. A webpage querying method, comprising:
receiving a first language word;
translating the first language word into at least a second language word with the same meaning;
transmitting the first language word to a plurality of websites comprising the first language word for query, and receiving a plurality of query results which comprising the first language word fed back by the websites;
transmitting the second language word to a plurality of websites comprising the second language word for query, and receiving a plurality of query results which comprising the second language word fed back by the websites;
translating the query result comprising the second language word into the first language; and
displaying the first language query result which includes word originally in the first language word and word translated from the second language word.

7. The webpage querying method according to claim 6, further comprising: pre-storing addresses of the websites and permitting edition of the addresses.

8. The webpage querying method according to claim 6, further comprising: pre-storing the first language word and the corresponding second language word, wherein the first language word is a mother language word, and the second language word comprises regional and national language family word.

9. The webpage querying method according to claim 6, wherein the step of transmitting the second language word to a preset website using the same language further comprises: transmitting at least a limiting condition to adjust the query result, the limiting condition at least comprising nation, file type or time range.

10. The webpage querying method according to claim 6, wherein the step of translating the first language word into the second language word with the same meaning further comprises: filtering the second language word according to a word field, and receiving a selection language family to filter the second language word.
